(19) United States
(12) Patent Application Publication
(10) Pub. No.: US 2004/0184059 A1
(43) Pub. Date: Sep. 23, 2004

(54) Printer language and program for generating same

(76) Inventors: Dennis Chun, Redondo Beach, CA (US); Ching-Lung Chen, Irvine, CA (US); Hung Yuan Tsai, Taichung (TW); Tsung Han Tsai, Hsinchu (TW); Wenhsiung Lee, Hsinchu (TW)

Correspondence Address: SONNENSCHEIN NATH & ROSENTHAL, Sears Tower, Wacker Drive Station, P.O. Box #061080, Chicago, IL, 60606-1080, US

(21) Appl. No.: 10/390,456

(22) Filed: Mar. 17, 2003

(51) Int. Cl. G06F 15/00

(52) U.S. Cl. 358/1.13; 358/1.16

(57) ABSTRACT

The present invention provides a limited capacity image-forming machine that includes a processor, a cache memory, and a storage device. The cache memory is in communication with the processor, wherein the cache memory stores a parameter. The storage device is in communication with the cache memory, wherein the parameter is copied from the cache memory to the storage device.

### BACKGROUND

This invention relates generally to image-forming machines and methods and, more particularly, this invention relates to a method and computer program for adjusting parameters in an image-forming machine.

Image-forming machines are commonly used to form or create images onto a substrate, such as paper. The image-forming machine often includes a print engine controller having a central processing unit (CPU) that runs firmware and which is used to control and operate a print engine within the image-forming machine. The print engine, and specifically devices within the print engine, are typically controlled using low-level commands that are typically issued by the CPU or by an application specific integrated circuit (ASIC). The print engine controller receives high-level commands, such as a “Print” command that instructs the image-forming machine to form an image. The high-level commands are then typically translated into low-level commands, such as “rotate” a roller or “warm up” a fuser, which are then received by these devices within the print engine. The high-level commands are generated by a program in a remote device, such as a computer, upon receiving an instruction to do so by a user. For example, if a user would like to form an image, the user will typically select a “Print” command from a program within the remote computer, and the program will then generate a printer language signal that includes high-level commands.

It would be desirable for a program to be able to generate a printer-language signal that includes both high-level and low-level commands that can be transmitted to the image-forming machine in order to control devices within the image-forming machine, and more specifically, within the print engine itself. Additionally, it would be desirable for a printer language to have the capability of being able to carry out low-level commands in addition to high-level commands. By including low-level commands in the printer language, the user is then afforded the capability of being able to directly control devices within the image-forming machine. Additionally, by including low-level commands in the printer language, the user can also adjust parameters of devices within the image-forming machine dynamically, or in “real-time.”

### BRIEF SUMMARY

According to one aspect of the present invention, a method of adjusting a parameter of a device within an image-forming machine is provided. The method includes providing an image-forming machine with a storage device, wherein the storage device stores the parameter. The method also includes dynamically adjusting the parameter stored in the storage device. In one aspect of the present invention, the method further includes providing the image-forming machine with a cache memory in communication with the storage device, wherein both the cache memory and the storage device store the parameter.

According to another aspect of the present invention, an image-forming machine is provided. The image-forming machine includes a processor, a cache memory, and a storage device. The cache memory is in communication with the processor, wherein the cache memory stores a parameter. The storage device is in communication with the cache memory, wherein the parameter is copied from the cache memory to the storage device.

According to another aspect of the present invention, a computer program for dynamically adjusting parameters in an image-forming machine is provided. The program includes a storage device and parameters list code on the storage device. The parameters list code provides a general list that lists at least one parameter that can be adjusted in the image-forming machine. The program also includes adjust parameters code and transfer code on the storage device. The adjust parameters code allows a user to adjust the parameter while the transfer code transfers the adjusted parameter from the storage device to a cache memory in the image-forming machine.

According to another aspect of the present invention, a printer language for sending and receiving information to and from an image-forming machine is provided. The printer language includes command information having low-level commands for controlling devices within the image-forming machine and high-level commands for controlling higher level devices within the image-forming machine. In one aspect of the present invention, the printer language further includes status information regarding the state of a device within the image-forming machine.

According to another aspect of the present invention, a computer program for dynamically adjusting parameters in an image-forming machine is provided. The computer program includes a storage device and low-level command generation code on the storage device for generating a low-level command for controlling devices within the image-forming machine. The computer program also includes high-level command generation code on the storage device for generating a high-level command, wherein the high-level command must be processed further in order to control devices within the image-forming machine.

The following drawings and descriptions set forth additional advantages and benefits of the invention. More advantages and benefits are apparent from the description and may be learned by practice of the invention.

### BRIEF DESCRIPTION OF SEVERAL VIEWS OF THE DRAWINGS

FIG. 1 illustrates a perspective view of an image-forming machine in communication with a remote computer, according to one embodiment;

FIG. 2A illustrates a block diagram of the image-forming machine of FIG. 1 in communication with the remote computer of FIG. 1, according to one embodiment;

FIG. 2B illustrates a block diagram of a printer language signal, according to one embodiment;

FIG. 2C illustrates a block diagram of firmware that is run by a print engine controller of an image-forming machine, according to one embodiment;

FIG. 2D is a flowchart illustration of methods, apparatus (systems) and computer program products, according to one embodiment;

FIG. 2E illustrates a block diagram of a queue, according to one embodiment;

FIG. 3 illustrates an opening screen of a program, according to one embodiment;

FIG. 4 illustrates an enlarged view of the opening screen of the program and a tool menu, according to one embodiment;

FIG. 5 illustrates one view of an engine settings window of a program, according to one embodiment;

FIG. 6 illustrates a second view of an engine settings window of a program, according to one embodiment;

FIG. 7 illustrates a belt settings window of a program, according to one embodiment;

FIG. 8 illustrates a toner bottle settings window of a program, according to one embodiment;

FIG. 9 illustrates a board test window of a program, according to one embodiment;

FIG. 10 illustrates an engine test window of a program, according to one embodiment;

FIG. 11 illustrates a high voltage (HV) settings window of a program, according to one embodiment;

FIG. 12 illustrates a patch printing window of a program, according to one embodiment;

FIG. 13 illustrates a feeder test window of a program, according to one embodiment; and

FIG. 14 is a flowchart illustration of methods, apparatus (systems) and computer program products, according to one embodiment.

For simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION

The present invention discloses methods, apparatus, and computer programs for adjusting parameters of devices in an image-forming machine and for obtaining status information from these devices. In particular, the present invention discloses a program which generates and uses a printer language signal that carries high-level and low-level commands. Accordingly, by providing a program that generates and uses a printer language signal that includes low-level commands, the program is able to cause specific devices (e.g. developer rollers, fuser heater, photoconductor drums, photoconductor belts) within the image-forming machine to generate status information regarding the current status or state of devices within the image-forming machine. Additionally, the program can also be used to dynamically adjust parameters, such as voltages supplied to certain devices, for specific devices within the image-forming machine 20. By being able to dynamically adjust certain parameters, the program allows a user to control and test and vary parameters of these devices in “real-time.” Additionally, by providing the user with a way to dynamically adjust certain parameters, the user is able to reduce the amount of time required to test and configure devices within the image-forming machine.

As will be appreciated by one of skill in the art, the present invention may be embodied as a method, data processing system or program. Accordingly, the present invention may take the form of an entirely hardware embodiment such as in a semiconductor device, an entirely software embodiment, or an embodiment combining software and hardware aspects. Furthermore, the present invention may take the form of a computer program product on a computer-readable storage medium having computer-readable program code embodied in the medium. Any suitable storage medium may be utilized including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

FIG. 1 illustrates an image-forming machine 20 in communication with a remote computer 50, in accordance with the present invention. Preferably, image-forming machine 20 is in communication with remote computer 50 using hard wiring, such as a cable 80, or transmitters and receivers which communicate wirelessly, such as infrared (IR) transmitters/receivers and radio frequency (RF) transmitters/receivers. Image-forming machine 20 may communicate with remote computer 50 using any type of I/O interface, such as IEEE-1284, IEEE-1394, USB 1.1/2.0, 10/100 Base T Ethernet, Gigabit Ethernet, 802.11 wireless standards such as 802.11b and 802.11g, Accelerated Graphics Port (AGP), PCI, PCI Express, ATA, Serial ATA, and SCSI.

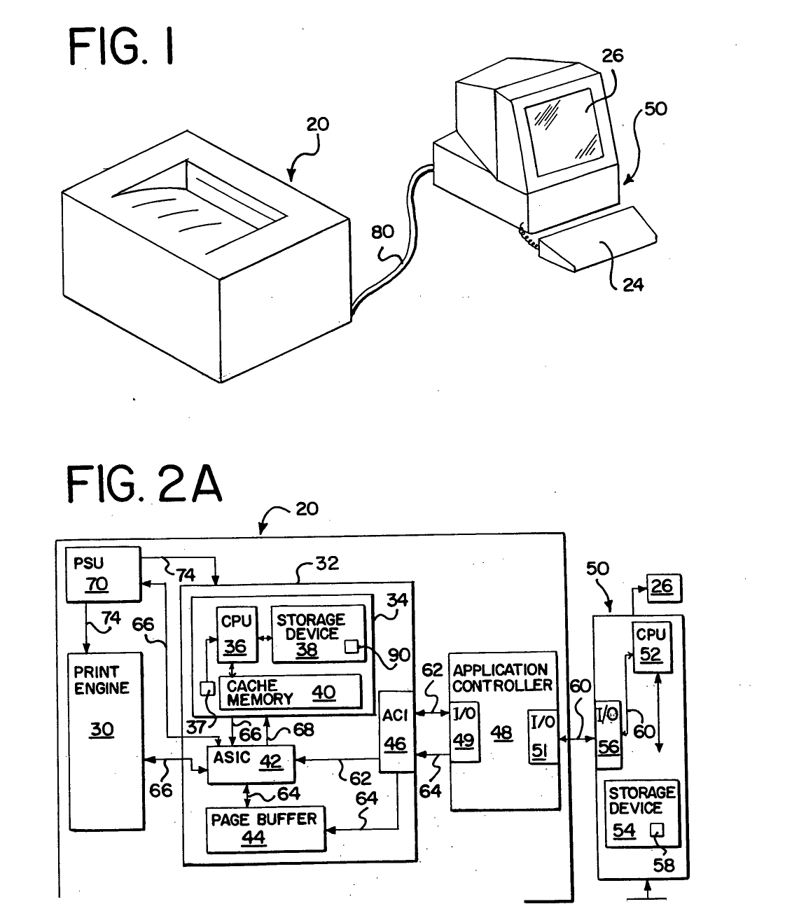

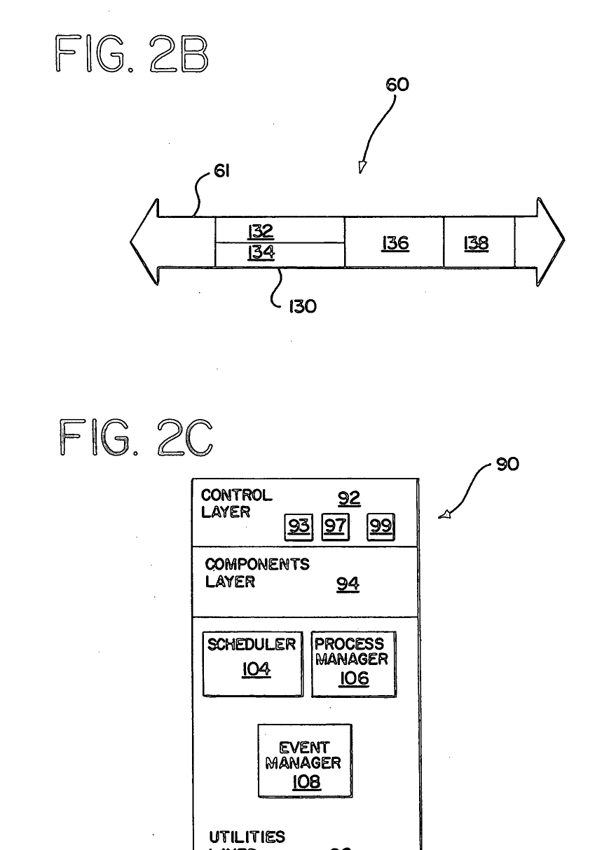

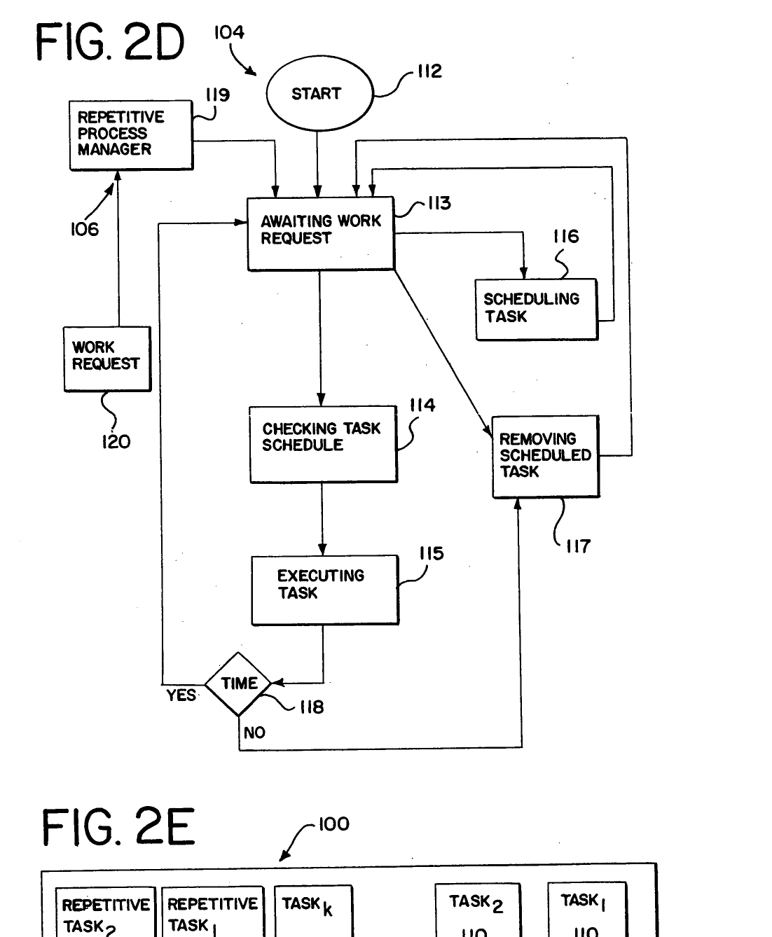

FIG. 2A illustrates a block diagram of the image-forming machine 20 and the remote computer 50, according to one embodiment. The image-forming machine 20 includes any type of machine that forms images, such as: electrophotographic image-forming machines such as copy machines, laser printers, and any other printer that uses charged toner particles to form an image and machines that form an image using ink such as ink jet, liquid toner, or dot matrix printers. In one embodiment, the image-forming machine 20 includes a print engine 30, a print engine controller 32, an application controller 48, and a power supply unit 70, which are all known herein generically as devices within the image-forming machine 20.

The print engine 30 is in communication with the print engine controller 32. The print engine 30 includes devices used for forming an image. In one embodiment, the print engine 30 includes mechanical and/or electrical devices (not shown) for forming an image, such as: a fuser assembly (not shown) having fuser rollers and fuser lamps for fusing toner particles to a substrate; a photoconductor (not shown) for developing an image and depositing toner onto the substrate; toner bottles (not shown) toner cartridges, or any other device used for storing the toner, generally known herein as a toner station; developer rollers for providing toner to develop a latent image on the photoconductor; chargers; cleaners; a tray (not shown) for holding the substrate; sheet feeders; and motors (not shown) for moving or rotating devices within the image-forming machine 20 such as rollers, belts, gears, and shafts; electronic components (not shown) such as resistors, capacitors, power supplies, circuit boards, and semiconductor devices such as, but not limited to: integrated circuits (e.g., memory cells such as SRAM, DRAM, EPROM, EEPROM, and the like); a programmable logic devices; data communications devices; clock generation devices; and so forth.

Additionally, the print engine 30 may include sensors (not shown) which monitor the mechanical and/or electrical devices within the print engine 30, such as: location sensors (not shown) for determining the location of the substrate; temperature sensors (not shown) for determining the temperature of a device (e.g. fuser roller) within the print engine 30, of the substrate, or of an area within the image-forming machine 20; humidity sensors (not shown) for determining the humidity of a device within the print engine 30, of the substrate, or of an area within the image-forming machine 20; power level sensors (not shown) for determining the amount of power used by a particular device; and voltage sensors (not shown) for determining the particular voltage between two points within the image-forming machine 20.

Moreover, the print engine 30 may include controllers (not shown) which can be used to control certain aspects of the mechanical and/or electrical devices, such as the amount of power or voltage received by a mechanical and/or electrical device, the rotational speed of a mechanical and/or electrical device, and/or the activity or inactivity of a mechanical and/or electrical device. Preferably, the controllers include a semiconductor device, such as a processor. The mechanical and/or electrical devices, the sensors, the controllers, and all other above-listed devices within print engine 30 are all known herein generically as devices within the print engine 30.

The print engine 30 receives low-level signals 66 from the print engine controller 32. The low-level signals 66 carry low-level commands 134, as further described below, which can be used to control devices within the image-forming machine 20, such as the print engine 30, and more particularly, such as mechanical and/or electrical devices, sensors, and controllers within the print engine 30. Additionally, the low-level signals 66 may also carry status information 136, as further described below, which describe the current state or status of a device within the image-forming machine 20. For example, status information 136 can contain information regarding the temperature measured by a particular sensor, or the speed at which a particular motor is rotating within the print engine 30. Moreover, print engine 30, and more specifically, devices within print engine 30, may generate and transmit low-level signals 66 to the print engine controller 32. In one embodiment, the print engine 30 generates low-level signals 66 that carry status information 136 about devices within the print engine 30.

The power supply unit (PSU) 70 supplies power, through a power signal 74, to devices within the image-forming machine 20, such as the print engine 30 and the print engine controller 32. The power supply unit 70 may send and receive low-level signals 66 to and from the print engine controller 32.

The print engine controller 32 is in communication with the print engine 30 and the application controller 48, as illustrated in FIG. 2A. The print engine controller 32, and elements within the print engine controller 32, may take the form of a semiconductor device or devices, as described above. The print engine controller 32 includes a print engine computer 34, an application specific integrated circuit (ASIC) 42, a page buffer 44, and an application controller interface (ACI) 46.

The print engine computer 34 includes a central processing unit (CPU) 36 which is in communication with a storage device 38, a cache memory 40, and a clock 37. The clock 37 provides the CPU 36 with a timing signal that allows the CPU 36 to properly execute commands. The CPU 36 executes system firmware 90 stored on the storage device 38 to control devices within the print engine 30. The CPU 36 uses the cache memory 40 to temporarily store information, such as firmware 90, for access by the CPU 36. Storage device 38 and cache memory 40 may comprise any suitable storage medium including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives. Preferably, storage device 38 comprises non-volatile memory, such as optical storage devices, or magnetic storage devices. The storage device 38 holds the firmware 90 and a list of various parameters 170. The parameters 170 detail the current settings 171 for devices within the image-forming machine 20 and can be modified toward controlling devices within the image-forming machine 20. The parameters 170 may include such information as the operating voltages of a particular device, the speed and the amount of rotation desired for a particular device, the time used to complete an operation using a particular device, the sequence for operating a series of devices, and any other type of information used to operate devices within image-forming machine 20. The print engine controller uses the values of the parameters 170 stored in the storage device 38 to generate the low-level signals 66 that carry low-level commands to the ASIC 42 and to other devices within the image-forming machine 20, such as the print engine 30 and the power supply unit 70.

The firmware 90, used in conjunction with the CPU 36, controls and runs tasks 110 within the image-forming machine 20. As will be appreciated by one of skill in the art, the firmware 90 may be embodied as a method, data processing system or program. Accordingly, the firmware 90 may take the form of an entirely hardware embodiment such as in a semiconductor device, an entirely software embodiment, or an embodiment combining software and hardware aspects. Furthermore, the firmware 90 may take the form of a computer program product on a computer-readable storage medium having computer-readable program code embodied in the medium. Any suitable storage medium may be utilized including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives. Tasks 110 are defined herein as work requests or actions that are performed by devices within the image-forming machine 20, preferably devices within the print engine 30, and controlled by the firmware 90. Tasks 110 include such things as managing the use of toner particles, positioning the belt, warming up the fuser lamp, and so forth.

The firmware 90 is preferably divided into three layers, a control layer 92, a components layer 94, and a utilities layer 96, as illustrated in FIG. 2C. The firmware 90 is built up from the functions of the devices within the image-forming machine 20 into a set of programs or utilities within utilities layer 96 that the components layer 94 and the control layer 92 use to perform the various work requests or tasks 110 necessary to comply with an end user request. In this scheme, each layer depends upon the layer beneath it, but objects within a layer, preferably, do not to refer to objects in the layer(s) above. For example, a fusing component within component layer 94 should not reference functions or data structures controlled by a printing service within control layer 92. Hiding the details of how a layer is implemented from other layers makes for program code that is less complex, modular and thus easier to change and integrate for use with new print engines. Each layer consists of a set of software objects each of which are defined by an application-programming interface, hereinafter, an “interface.” Each object's interface specifies which functions can be called, what parameters can be provided to them and what results can be expected from them. The interfaces are the building blocks towards a modular, flexible and efficient software system.

The control layer 92 contains functions that control high-level system processes, such as, program code execution flows, control sequencing, sustaining print quality and responding to requests for performing tasks 110. The control layer 92 interprets and responds to high-level commands 132 for tasks 110 to be performed, among them including printing, calibration, engine status and power control. For the most part, the control layer 92 governs the overall operation of the image-forming machine 20, leaving the details of performing tasks 110 to the devices within the image-forming machine 20. With some exceptions, the processes within the control layer 92 are designed to be interruptible so that control of the more time-critical tasks 110 of the print engine are not hampered by processes at the control layer 92.

The control layer 92 is divided into client services 93, engine controls 97, and quality controls 99, as illustrated in FIG. 2C. The client services 93 include such items as the printer language 61 which is used to allow clients of the print engine controller 32, such as the application controller 48, to communicate to the print engine 30. The application controller 48 includes an input/output (I/O) device 49, as described below, that preferably adheres to a proprietary hardware protocol, which is part of the application controller interface (ACI) 46 that logically connects the application controller 48 to the ACI 46. The type of application controller attached to the print engine controller 32 determines how the image-forming machine 20 is manipulated and controlled. For example, a development application controller, such as program 58, can connect a computer, such as remote computer 50, with the print engine 30 to produce an environment for testing and controlling all of the specific devices within the print engine 30.

The printer language 61 is a command-based interface that pushes data from a client to devices within the print engine 30. In one embodiment, commands cannot flow from devices within the print engine 30 to a client, such as the remote computer 50, and as such, the client is expected to occasionally prompt devices within the print engine 30 using low-level commands 134 for available responses. There is a facility for devices within the print engine 30 to notify the host, such as program 58, via an interrupt, which can be used to signal the host to send command information 130. Preferably, information is transmitted in the printer language 61 one byte at a time to avoid possible byte-ordering differences between the two controllers. The commands, which include command information 130, status information 136, and data information 138, provided by the printer language 61 may include executing special functions and operating modes; downloading raw or compressed page images for printing; changing system configuration and operating set-points; acquiring charger and electrophotographic module statistics data; acquiring system capability and identification; powering up, down and resetting the engine; defining job control attributes; upgrading system firmware; monitoring engine status; and clearing faults. Most commands are available to all clients, however a subset of them are used exclusively for engine development that are not available to clients outside of diagnostics and manufacturing environments. In one embodiment, the client services 93 also include the ability to upgrade the firmware 90.

The engine controls 97 within the control layer 92 includes operating modes and other controls which allow for controlling certain upper-level functions of the print engine 30, such as initialization, standby, ready, printing, fault, diagnostics, and power-save. Each of these operating modes performs a particular function, defines specific entry and exit criteria for transitioning between them, and contains certain control processes within them. The engine controls 97 also include a control state manager for governing the transitioning from one operating mode to another. The control state manager also allows the mode switching action to be performed in a similar and consistent manner regardless of which mode is being switched from or to.

The control layer 92 also includes quality controls 99 to help deliver satisfactory output quality over the life of the image-forming machine 20. The quality controls include tasks 110 such as a toner concentration process that maintains a proper ratio of toner-to-carrier within the developer housing; a toner density process that uses a patch sensor to measure the amount of toner mass to area on a specific section of a photoconductor within the image-forming machine 20; and a transfer efficiency process for measuring the efficiency of the transfer function is available within the print engine 30.

The components layer 94 includes various objects or components that represent each of the specific devices within the print engine 30. For each print engine component, the component layer 94 includes a set of component operations. Each set of component operations offers at least an operation for initializing itself, for reporting status, and for shutting down. This could allow the control layer 92, for example, to initialize each of the components simultaneously, taking advantage of potential parallelism in the image-forming machine 20 to improve response time. Additionally, each set of component operations offers one or more operations for transitioning between the normal operating states of the printing cycle: pre-print, print, post-print. Other component operations which may or may not be included in all components include life statistics, simulation and diagnostics. In a preferred embodiment, configuration parameters would not be controlled by component operations, but instead by the data manager. This allows more preferred approach control over initialization and access to system data set points.

The higher-level control layer 92 need not have access to specific device operations. Instead it can make a general call to the components layer 94 to enable the device's function. For example, a printing service does not need specifics of the photoconductor to initiate printing. For instance, the control layer 92 might not know that the photoconductor is an organic photoconductor (OPC) belt that uses two motors and a data structure called a “ramp table” to ramp up the speed of both of the motors to bring the belt to printing speed, but the printing service does need a specific function that it can invoke to make the photoconductor ready for printing a color page. The more specific implementation is completely contained within a component within the components layer 94 and as such is hidden from all other components and layers. In the instances where there is data known to a component within the components layer 94 that the control layer 92 needs to be aware of, a public interface would be made available for use by the image-forming machine 20.

The components layer 94 includes various components that represent devices within the print engine 30, such as: a blower fan component that is used to control a blower fan for cooling down the ambient internal temperature of the engine; a casing component that is used to control all hardware functions that are visible to the user and not represented by the other components, such as cover sensors and power switches; a charger component that is used to control a charger module for creating an uniform voltage potential on the photoconductor to enable toner development on the photoconductor; a cleaner component that is used to control a cleaner module for removing excess toner from the photoconductor; a controller component that is used to control the print engine controller 32 and devices within the print engine controller 32; a control panel component that is used to control buttons, selectors, LED indicators or an LCD text display on the print engine controller 32; a developer component that is used to control a developer station that contains developer material which when exposed to a charged photoconductor transfers toner based on photoconductor's latent image; an eraser component that is used to control eraser lamps stationed just before each physical charger that when turned on discharges the scanlines on the photoconductor to the same potential; a fuser component that is used to control a fuser that fixes the transferred toner onto the media by a heated roller nip; an input tray component that is used to control an input tray which supplies the media or substrate onto which toner will be transferred; an exposure component that is used to control the exposure unit (e.g. an LED print head module that contains an array of light-emitting diodes) to “expose” the photoconductor with the page image stored in the page buffer 44 of the print engine controller 32; an output tray component that is used to control an output tray that catches the substrate ejected from the fuser nip; a patch sensor component that is used to control a patch sensor that measures toner density on the photoconductor; a power supply component that is used to control the power supply unit 70 that regulates both high and low voltage distribution to the various devices within the image-forming machine 20; a toner bottle component that is used to control a toner bottle that supplies toner to the developer housing; a transfer component that is used to control a transfer module which includes a roller that accepts a charge potential that when engaged is used to feed substrate into the fuser nip, and while doing so transferring toner from the photoconductor onto the media; and other such components to control other such devices within the image-forming machine 20. Notably, various ones of the foregoing components may be used repeatedly to control each individual toner colors, developers, chargers, and exposure units particularly in color print engines.

The firmware 90 also includes a utilities layer 96 that includes utilities to enable parallelism in the image-forming machine 20 so that the print-engine 30 operates efficiently. Most of the utilities are time-related because the image-forming process may require strict control of the devices within the image-forming machine 20 at specific points in time, especially if the image-forming process is an electrophotographic process. The utilities layer 96 uses the resources of the devices within the image-forming machine 20 to notify the upper component and control layers 94, 92 when a particular task has occurred, or to perform a specific action at an expected time. Thus, the utilities layer allows for the upper components and control layers 94, 92 to not spend time waiting for tasks 110 and to continue performing other functions as needed. The utilities layer 96 includes utilities such as a real time task scheduler 104, a repetitive process manager 106, and a task manager 108, as illustrated in FIG. 2C.

The real time task scheduler 104 defines and manages a queue 100 which contains a task 110 or plurality of tasks 110 to be performed after a predetermined time has expired, as illustrated in FIGS. 2C and 2E. The queue 100 is essentially a holding place which organizes and sorts tasks 110 that are to be performed by the CPU 36. The order and place within the queue 100 of the tasks 110 is determined by the real time task scheduler 104. Preferably, the scheduler 104 manages all of the tasks 110 for the image-forming machine 20 allowing other portions of the firmware 90, specifically the upper layers of the firmware 90, to avoid having to deal directly with managing the tasks 110 and using timer and interrupt resources. Since the tasks 110 will be managed in “real-time,” that is, as the tasks 110 are being processed, the tasks 110 must occur at exactly the right moment in time in order to expeditiously produce the correct output. The scheduler 104 relies on the assumption that certain tasks 110 will take a certain, predetermined amount of time. By using a predetermined amount of time to schedule tasks 110, the scheduler 104 may schedule tasks 110 in real-time without having to use the resources of the upper levels 92, 94. Preferably, the scheduler 104 uses a timer, such as a clock signal generator 37, for receiving a clock signal that is used to measure time and manage and sort the tasks 110 within the queue 100. The clock signal generator 37 allows the scheduler 104 to execute tasks 110 at just the right moment planned. In one embodiment, the scheduler 104 uses a variable time space manageable clock source to generate a clock signal, as described below, instead of or in addition to the clock signal generator 37. The scheduler 104 schedules each task 110 to be executed for a predetermined amount of time instead of trying to determine the amount of time as the task is going on. In addition to providing real-time execution, the scheduler 104 allows simplified coding since tasks 110 may now be broken up into their constituent subtasks and properly queued to achieve the desired operational order and timing.

The task manager 108 works in much the same manner as the scheduler 104, except that the task manager 108 uses a variable time space manageable clock source instead of a timer to keep track of time for time independent tasks 109. The task manager 108 may be used in conjunction with the real time task scheduler 104 or it may function separately from the real time task scheduler 104. If the task manager 108 is used in conjunction with the scheduler 104, then all the tasks 109, 110 handled by the task manager 108 and the scheduler 104 may be scheduled in the same queue, such as queue 100, as illustrated in FIG. 2E. The task manager 108 manages and monitors a predefined sequence of time independent tasks 109 which are dependent on a variable time space manageable clock source instead of a timer as in the scheduler 104. These time independent tasks 109 may be placed in separate queue from the tasks 110, or all placed in the same queue. The time independent tasks 109 are arranged accordingly by the task manager 108. A variable time space manageable clock source will generate a clock signal in variable time increments that do not depend on time. A variable time space manageable clock source can be any device within image-forming machine 20, and preferably, print engine 30, that can be used to generate a signal based upon a parameter. For example, a device within image-forming machine 20 can be used to generate a clock signal based upon the movement of the device or the position of the device. In one embodiment, the rotational speed of the photoconductor functions as a variable time space manageable clock source. By using a variable time space manageable clock source to manage the tasks 109, the task manager 108 is able to closely map mechanical functionality within the print engine 30 to software functionality.

The repetitive process manager 106 may be run in conjunction with the real time task scheduler 104. The repetitive process manager 106 also monitors the incoming work requests. If a single work request must be repeatedly scheduled or scheduled a multiple number of times, the repetitive process manager 106 receives the single work request and issues multiple work requests to the real time task scheduler 104, which in turn schedules repetitive tasks 111 in the queue 100, as illustrated in FIG. 2E. Preferably, the processes within the repetitive process manager 106 occur at some time delta measured in real time as opposed to the external clock cycles from clock 37. Once registered, the repetitive process manager 106 predetermines a schedule of tasks 110, 111 for some duration X, in which X can be derived to effectively make use of the timer settings for the repetitive tasks 111. The repetitive process manager 106 allows access to turn on or off these processes at any time, thus saving processing time in the CPU 36 when these processes are no longer necessary.

FIG. 2D is a flowchart illustration of methods, apparatus (systems) and computer program products according to the invention. It will be understood that each block of the flowchart illustration in FIG. 2D, and combinations of blocks in the flowchart illustration in FIG. 2D, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a storage device that can direct a computer or other programmable data processing apparatus to function in a particular manner, such that the instructions stored in the storage device produce an article of manufacture including instruction means which implement the function specified in the flowchart block or blocks. The computer program instructions may also be loaded onto a computer or other programmable data processing apparatus to cause a series of operational steps to be performed on the computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustration in FIG. 2D support combinations of means for performing the specified functions, combinations of steps and program instruction means for performing the specified functions. It will also be understood that each block of the flowchart illustration in FIG. 2D, and combinations of blocks in the flowchart illustration in FIG. 2D, can be implemented by special purpose hardware-based computer systems which perform the specified functions or steps, or combinations of special purpose hardware and computer instructions.

As seen in FIG. 2D a start operation is initiated in block 112. The start operation initiates the real time task scheduler 104. Upon initiating the real time task scheduler 104 in block 112, the scheduler 104 then begins to wait for a work request at block 113. Work requests are generated at block 120. Once a work request is generated, the work request is received by the repetitive process manager 106 at block 119. Upon receipt, the repetitive process manager 106 determines how to best schedule the work request and in turn sends the work requests to block 113 of the scheduler 104. Upon receiving a work request, the scheduler 104 then moves to either block 116 or block 117 depending upon the type of work request. If the work request is to perform a specific task, the scheduler 104 then moves to block 116 and schedules a task 110 by placing the task 110 in the queue 100. Upon scheduling a task, the scheduler 104 then moves back to block 113 to await a further work request. If the work request is to stop performing a certain task, then the scheduler 104 moves to block 117 and removes the certain scheduled task from the queue 100. Upon removing the task from the queue 100, the scheduler 104 then moves back to block 113 and awaits a further work request. As the scheduler 104 is waiting for a work request at block 113, the scheduler 104 is also prompted to act at each clock cycle of the clock 37. Upon each clock cycle, the scheduler 104 moves to block 114 and checks the queue 100. If there is still a scheduled task 110, the CPU 36 then executes the task 110, as shown in block 115, and then moves to block 118. At block 118, the scheduler 104 determines if the time allotted for the task has expired. If the allotted time for a task 110 has expired, the scheduler 104 moves to block 117 and removes the task 110 from the queue 100. If the scheduler 104 determines that the time allotted for task has not expired, then the scheduler 104 moves to block 113 and waits for a work request.

The print engine computer 34 is in communication with the ASIC 42. ASIC 42 and the print engine computer 34 work together to control the print engine 30. Preferably, the firmware 90 works in conjunction with the ASIC 42 in order to maximize the overall performance of the print engine controller 32. In one embodiment, print engine controller 32 may offer a field programmable gate array (FPGA) in place of the ASIC 42 until circuitry design and function is finalized. This embodiment may require additional memory for storing the FPGA program data and downloading/initialization support by the system firmware 90.

ASIC 42 receives command/status signals 62 from the application controller 48. The command/status signals 62 carry low-level commands 134 and high-level commands 132. The low-level commands 134 are then communicated to devices within the image-forming machine 20, such as the print engine 30, a scanner (not shown) or communication device (not shown), using low-level signals 66, as described above. The high-level commands 132 are then communicated to and processed by the print engine computer 34, for example, using high-level signals 68. High-level commands 132 are commands that are received by the image-forming machine 20 and are used for controlling higher level devices, such as CPU 36, within the image-forming machine 20. High-level commands 132 need to be further processed into low-level commands 134 in order to control and/or prompt various specific devices within the image-forming machine 20. High-level commands 132 are executed by the print engine computer 34, and more specifically, by the CPU 36. The print engine computer 34 generates low-level commands 134 as a result of receiving the high-level commands 132.

In one embodiment, upon receiving a particular high level command 132, the print engine computer 34 may dynamically adjust the value of parameters 170 stored within the storage device 38. The print engine computer 34 in turn generates low-level signals 66 that include low-level commands 134. The low-level signals 66 generated by the print engine computer 34 are in turn communicated back to the ASIC 42. Preferably, the ASIC 42 includes special-purpose registers (not shown) which control certain basic internal functions of the ASIC 42. The command/status signals 62 may also carry status information 136 received from devices within the image-forming machine 20.

The ASIC 42 is also in communication with the page buffer 44. The page buffer 44 is used to temporarily store data information 138 until the page buffer 44 is prompted by the ASIC 42 for the data information 138. The data information 138 contains information that is specific for reproducing a particular image, as described below. Upon being prompted for data information 138 by the ASIC 42, the page buffer 44 generates data signals 64 that carry data information 138. Preferably, the page buffer 44 comprises a storage device, as described above.

ACI 46 is in communication with the ASIC 42 and the page buffer 44. ACI 46 includes a hardware interface that is in communication with the application controller 48 and other devices within the print engine controller 32, such as the ASIC 42 and the page buffer 44. ACI 46 receives command/status signals 62 to and from the application controller 48 which are in turn transmitted to the ASIC 42. ACI 46 receives data signals 64 from the application controller 48 and transmits the data signals 64 to the page buffer 44. ACI also receives command/status signals 62 from the ASIC 42 which are in turn transmitted to the application controller 48. In one embodiment, ACI 46 uses a proprietary I/O interface.

Application controller 48 includes a first I/O interface 49 and a second I/O interface 51. The first I/O interface 49 is in communication with the ACI 46 and sends and receives command/status signals 62 to and from the ACI 46. The first 110 interface 49 also sends data signals 64 to the ACI 46. The first I/O interface 49 uses the same hardware interface used by ACI 46 so that the first I/O interface 49 can communicate with the ACI 46. Since the interface between the application controller 48 and the ACI 46 are compatible, different print engines 32 may be used with, and can communicate with, application controller 48 so long as the print engine controllers 32 include an application controller interface that uses the same proprietary I/O interface used by first I/O interface 49, such as ACI 46.

The second I/O interface 51 is in communication with a third I/O interface 56 located in the remote computer 50. The second I/O interface 51 sends and receives a printer language signal 60 to and from the third I/O interface 56. The printer language signal 60 includes command information 130, such as high-level commands 132 and low-level commands 134; status information 136; and data information 138, as illustrated in FIG. 2B. The first 110 interface 49, the second I/O interface 51, and the third I/O interface 56 may include any type of I/O interface, such as IEEE-1284, IEEE-1394, USB 1.1/2.0, 10/100 Base T Ethernet, Gigabit Ethernet, 802.11 wireless standards such as 802.11b and 802.11g, Accelerated Graphics Port (AGP), PCI, PCI Express, ATA, Serial ATA, and SCSI. Preferably, the second and third I/O interfaces 51, 56 include the same type of interface so that they can communicate with each other. Since the second and third I/O interfaces 51, 56 between the application controller 48 and the remote computer 50 are compatible, the remote computer 50 may be able to communicate directly with devices within the image-forming machine 20.

Remote computer 50 includes a central processing unit (CPU) 52 in communication with a storage device 54 and the I/O interface 56, as illustrated in FIG. 2A. Storage device 54 stores data, such as program 58, which is later accessed by the CPU 52. CPU 52 executes program 58 stored on the storage device 54 to test and control devices within the print engine 30. CPU 52 generates the printer language signal 60 which carries printer language information 61. Print language information 61 includes command information 130, status information 136, and data information 138, as illustrated in FIG. 2B.

Command information 130 instructs devices within the image-forming machine 20, such as the print engine 30 and the print engine computer 34, to perform certain tasks 110. Command information 130 is divided into high-level commands 132 and low-level commands 134. High-level commands 132 are commands that are received by the image-forming machine 20 and that need to be executed by the print engine computer 34. The print engine computer 34 may generate low-level commands 134 as a result of receiving the high-level commands 132.

Low-level commands 134 are commands that are directly received by and used to control and/or prompt devices within the image-forming machine 20, such as the ASIC 42, the PSU 70, or the print engine 30. Low-level commands 134 do not need to be executed by the print engine computer 34, but rather may be sent directly to devices within the image-forming machine 20 in order to control and/or prompt these devices. In one embodiment, the low-level commands 134 are used to directly control devices within the image-forming machine 20 at the signal level. Low-level commands 134 generated by the program 58 may be carried through printer language signals 60, and later through low-level signals 66, to devices within the image-forming machine 20, such as the print engine 30, in order to control and/or prompt these devices. For example, low-level commands 134 may be carried to a device, such as a motor within print engine 30, to prompt that device for status information 136, such as the current speed of that motor. Additionally, low-level commands 134 may be carried to a device, such as a fuser assembly, to control a certain parameter 170 of that device, such as controlling the amount of heat generated by the fuser assembly, the speed at which the fuser roller rotates, the amount of fuser oil applied to the roller, and other such things. Preferably, the low-level commands 134 do not need to be processed by an intermediate device, such as a processor (CPU, ASIC, FFGA, etc.), but rather can be routed directly to a device in order to directly control or prompt that device.

Status information 136 is generated by devices within the image-forming machine 20 and includes information about the status or state of a device within the image-forming machine 20. For example, status information 136 can contain information about the temperature of a certain device within the print engine 30, or information about motor speed, voltages and/or currents for certain sensors within the print engine 30. Status information 136 may be generated by a device as a result of receiving a low-level command 134, or status information 136 may be generated by a device without receiving a low-level command 134, such as in the case of a device that periodically generates status information 136.

Data information 138 is generated by a program within the remote computer 50, such as program 58, and contains information that is specific for reproducing a particular image. Data information 138 can include information about the size, shape, and color of an image that is to be reproduced by image-forming machine 20.

Remote computer 50 also includes an input device 24 and a display device 26. Display device 26 is used to display information that has been generated by CPU 52. The contents of the display device 26 may be controlled or altered by the program 58, the CPU 52, or an operating system residing within the storage device 54, either individually or in combination. The display device 26 can include any type of device used to display information, such as a cathode ray tube, a liquid crystal display, or a plasma display.

Program 58 executes in CPU 52 from storage device 54 to dynamically adjust and/or dynamically monitor devices within image-forming machine 20. As used herein, the term “dynamically adjust” is defined herein as the ability of a user to control and adjust parameters, such as parameters 170 within the image-forming machine 20, in “real-time,” that is, nearly instantaneously or as the image-forming machine 20 is in operation. As used herein, the term “dynamically monitor” means that a user can monitor the value of parameters 170 within the image-forming machine 20 in “real-time,” that is, almost instantaneously. Program 58 generates and uses printer language 61 that includes low-level commands 134 which can be used to dynamically adjust parameters 170 in image-forming machine 20. In one embodiment, program 58 is able to send and receive low-level signals 66 which contain low-level commands 134 to adjust parameters 170 of devices within image-forming machine 20, and generate status information 136 from devices within the image-forming machine 20 for obtaining the current state or status of those devices. Program 58 may be used to control devices within the image-forming machine 20 by generating printer language 61 that includes command information 130. Program 58 may be used to test devices within the image-forming machine 20 by generating printer language 61 that includes data information 138 which is then sent to the devices within the image-forming machine 20. Upon receiving the data information 138, the devices within the image-forming machine 20 form an image. Additionally, program 58 is able to monitor devices within the image-forming machine 20 by receiving printer language 61 that includes status information 136.

The program 58 operates upon receiving input from a user. For obtaining input from a user, remote computer 50 utilizes the input device 24 (e.g. a keyboard, mouse or other user input device), as illustrated in FIG. 1. Input devices 24 may be used to designate areas or select certain areas within the display device 26 by performing a pointing operation on those areas. Input devices 24 may also be used to input information, such as the name of a test that the user would like to perform on the image-forming machine 20. In one embodiment, input device 24 is used to operate certain functions within program 58 so that a user can control, test, and monitor devices within image-forming machine 20. Input devices 24 may include pointing devices, such as a mouse, a trackball, a touch pad, and a graphics tablet; keyboards; stylus; and buttons. Pointing devices allow a user to move a mouse pointer displayed on the display device 26 over an object located on the display device 26, to select that object. A stylus can be used to input text and other information and select objects on the display device 26. A keyboard and/or a button can also be used to input text and other information and select objects displayed on the display device 26.

Upon operation, program 58 preferably displays an opening screen 150, as illustrated in FIG. 3. The opening screen 150 includes a series of menus 161, such as a file menu 151 for opening different files, a tool menu 152 to be described below, a view menu 153 for viewing the information on the display device 26 in a different manner, a window menu 154 for opening new windows and changing windows, and a help menu 155 for obtaining help in operating program 58. The opening screen 150 also includes a series of windows 162 within the opening screen 150, such as a source file window 156, a preview window 157, a file print window 158, and a status window 160. The source file window 156 displays the location of files 159 used by the program 58 and allows a user to select and open files 159 to be used by the program 58. The preview window 157 displays an image of how a selected file 159 should look once formed by the image-forming device 20. The file print menu 158 displays the names of selected files 159 which are to be formed by the image-forming device 20. The status window 160 displays the status of the current operation and includes information such as the name and the size of the selected file 159 to be formed, the number of copies to be formed, and other information regarding the status of the current operation.

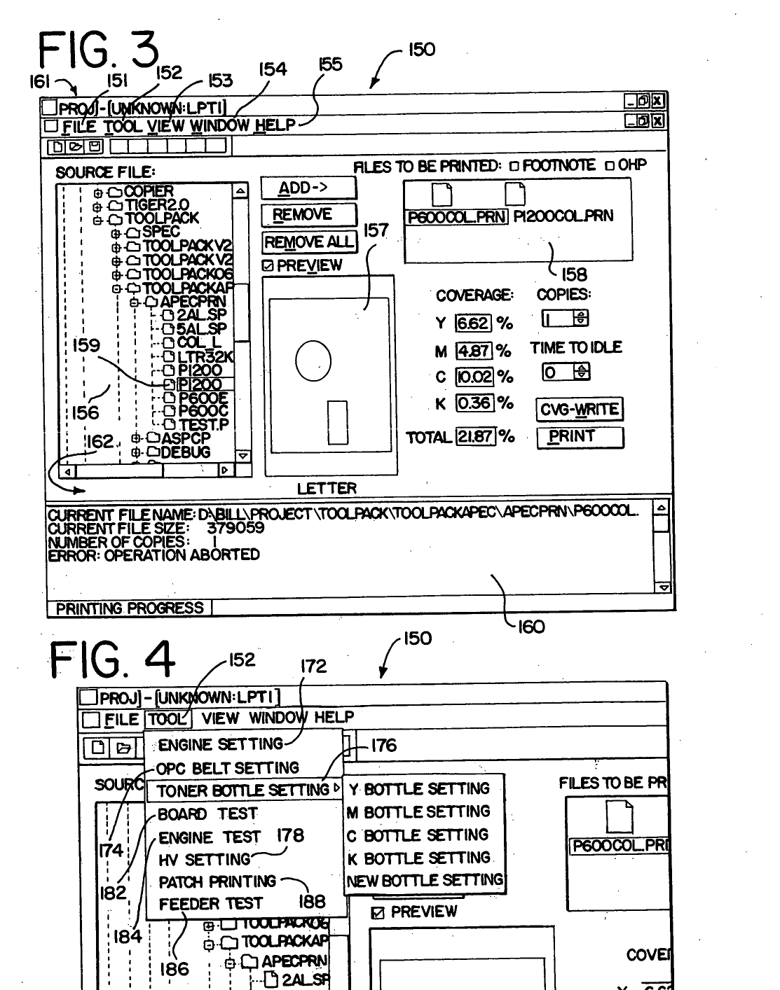

The tool menu 152 lists various items that can be selected by the user and which cause additional windows to open and allow the user to dynamically adjust, test, and dynamically monitor devices within image-forming machine 20, as illustrated in FIG. 4. For example, the tool menu 152 may include items such as engine settings item 172, belt settings item 174, toner station settings item 176, high voltage (HV) settings item 178, board test item 182, engine test item 184, feeder test item 186, and patch printing item 188.

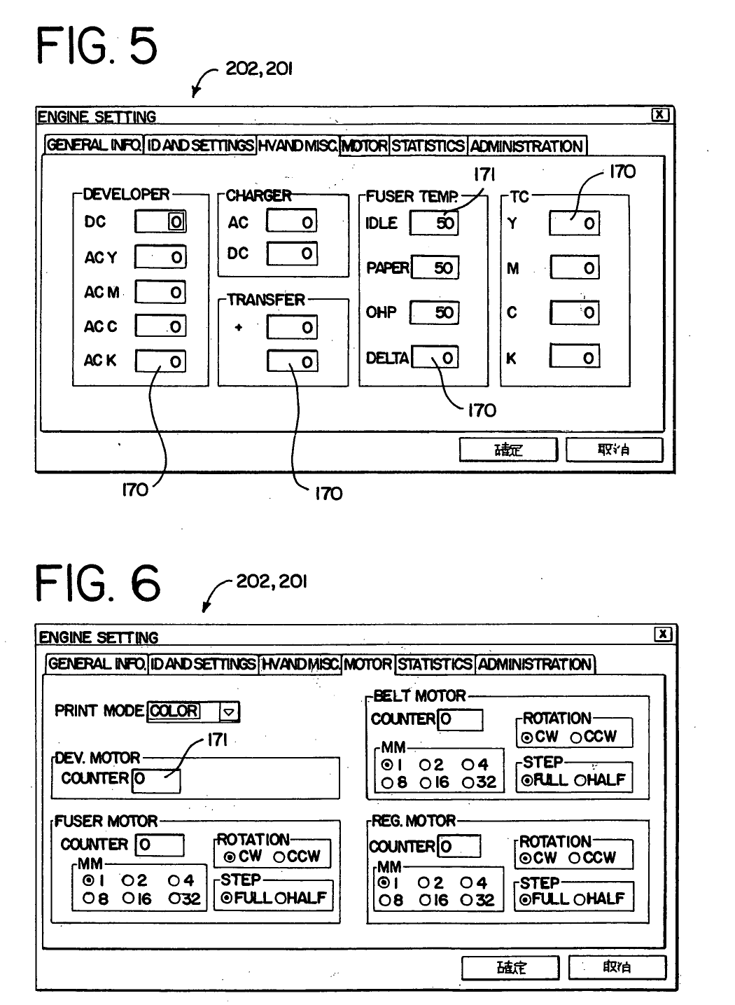

Once a user selects an item within the tool menu 152, such as the engine settings item 172, the program 58 will generate a window 200, such as an engine settings window 202, as illustrated in FIGS. 5 and 6. Some of the information displayed within the window 200, such as the current settings 171 of devices, is generated from status information 136. From within the window 200, a user can view settings 171 which detail the current settings of devices within the image-forming machine 20, statistical information about devices within the image-forming machine 20 that is saved, and other information regarding devices within the image-forming machine 20 that may be obtained as a result of status information 136 being received by the program 58. In addition to viewing various information, the user can control and dynamically adjust a variety of parameters 170 from within the window 200 by changing the value of the parameters 170. Parameters 170 may include such things as, for example, the rotational direction, the velocity, and/or the state for various devices within the print engine 30. Once the value of the parameters 170 is changed and the change is applied, the program 58 then generates printer language 61 that includes low-level command information 134 that is sent to the image-forming machine 20 and used to dynamically control devices within the image-forming machine 20.

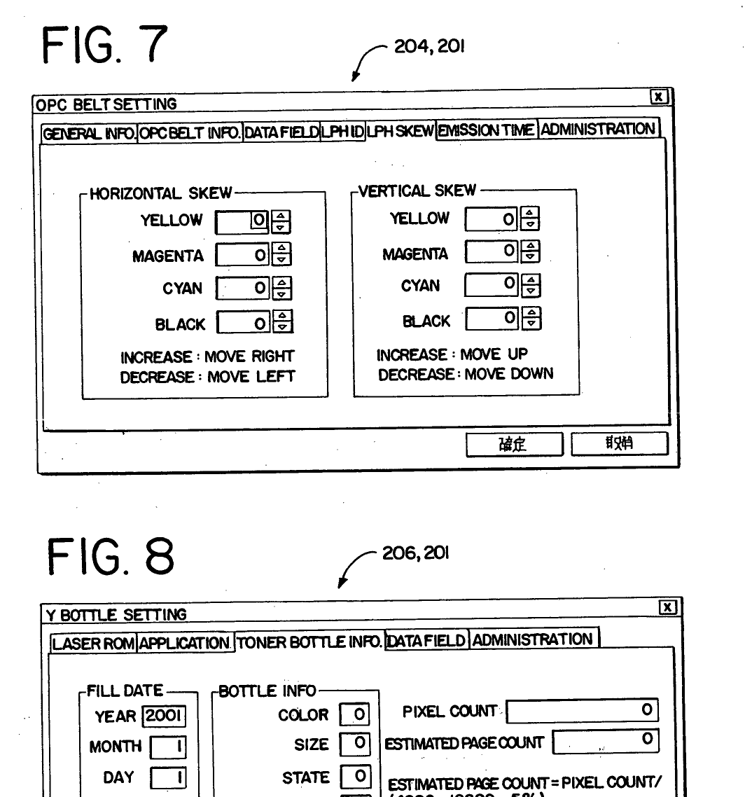

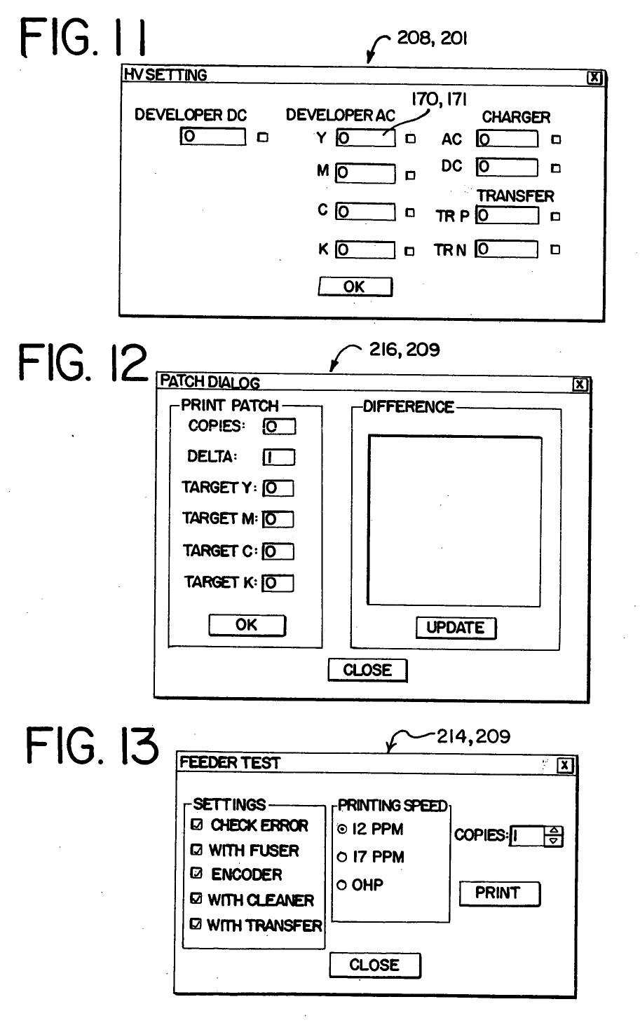

In one embodiment, window 200 comprises a settings window 201, such as an engine settings window 202, for monitoring and adjusting various parameters 170 within the image-forming machine 20 and for displaying a variety of settings 171, as illustrated in FIGS. 5 and 6. Settings window 201 can include a variety of windows, such as engine settings window 202 for monitoring and adjusting various parameters within the print engine 30, belt settings window 204 for monitoring and adjusting various parameters for the belts found within the print engine 30, toner station settings window 206 for the toner stations found within the print engine 30, and HV settings window 208 for monitoring and adjusting various parameters within the power supply unit 70 and devices within the print engine 30, as illustrated in FIGS. 5-8 and 11. From within the settings window 201, a user can view the settings 171 regarding devices within the image-forming machine 20 and control and dynamically adjust parameters 170, for a variety of devices within image-forming machine 20. Once the value of the parameters 170 is changed and the change is OK'd or applied, the program 58 then generates printer language 61 that includes low-level command information 134 that is sent to the image-forming machine 20 and used to dynamically control devices within the image-forming machine 20.

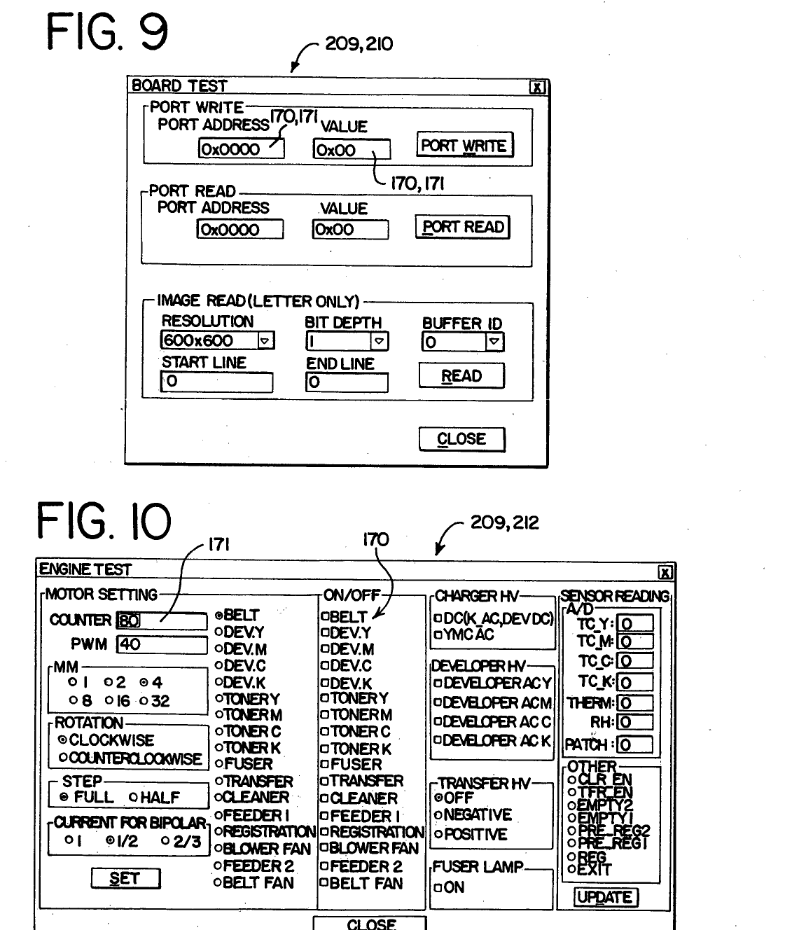

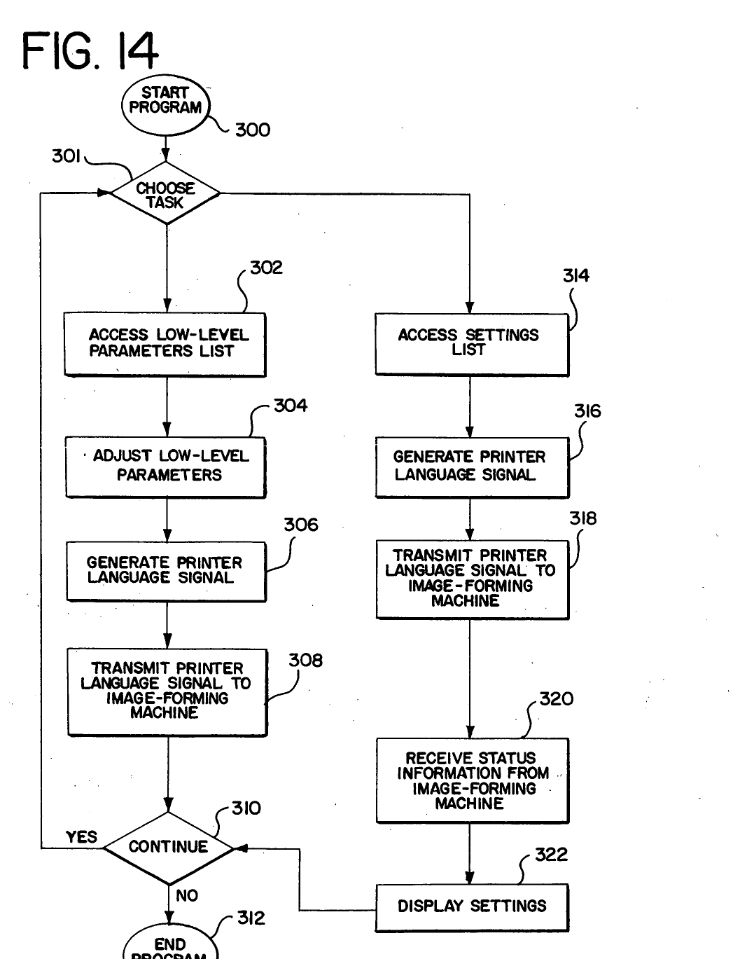

In one embodiment, window 200 comprises a testing window 209, such as an engine test window 212, for testing various devices within the image-forming machine 20 and for displaying a variety of settings 171 and parameters 170, as illustrated in FIG. 9. Testing window 209 can include a variety of windows, such as board testing window 210 for testing devices within the print engine controller 32, engine test window 212 for testing devices within the print engine 30, feeder test window 214 for testing the feeders within the print engine 30, and patch printing window 216 for testing the capability of the image-forming machine 20 to form an image, as illustrated in FIGS. 9, 10, 12, and 13. From within the testing window 209, a user can view general information about settings 171 of devices within the image-forming machine 20 and parameters 170 which the user can control and dynamically adjust, such as, for adjusting parameters of devices within the print engine 30. For example, the user can turn on and off a variety of devices within the image-forming machine 20, such as, belts, motors, fusers, developer sleeves, sheet feeders, toner augers, and fans. Once the value of the parameters 170 is changed and accepted (e.g. by clicking “OK” or “APPLY”), the program 58 then generates printer language 61 that includes low-level command information 134 that is sent to the image-forming machine 20 and used to dynamically control devices within the image-forming machine 20 by superceding parameter 170 that may have been previously written in one of the storage devices within the image-forming machine 20, most likely a rewritable non-volatile memory. Additionally, if desired, the program 58 may generate and send data information 138 to the image-forming machine 20 in order to test the ability of the image-forming machine 20 to form images.

FIG. 14 is a flowchart illustration of methods, apparatus (systems) and computer program products according to the invention. It will be understood that each block of the flowchart illustration in FIG. 14, and combinations of blocks in the flowchart illustration in FIG. 14, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a storage device that can direct a computer or other programmable data processing apparatus to function in a particular manner, such that the instructions stored in the storage device produce an article of manufacture including instruction means which implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions which execute on the computer or other programmable apparatus provide steps for implementing the functions specified in the flowchart block or blocks.

Accordingly, blocks of the flowchart illustration in FIG. 14 support combinations of means for performing the specified functions, combinations of steps for performing the specified functions and program instruction means for performing the specified functions. It will also be understood that each block of the flowchart illustration in FIG. 14, and combinations of blocks in the flowchart illustration in FIG. 14, can be implemented by special purpose hardware-based computer systems which perform the specified functions or steps, or combinations of special purpose hardware and computer instructions.

As seen in FIG. 14 a start program operation is initiated in block 300. The start program operation initiates program 58 and displays opening screen 150 on the display device 26. Upon initiating the start program operation in block 300, the user is presented with the option to choose a task he would like the program 58 to perform at block 301. The user may select to either access and edit parameters 170, as shown in block 302, or access and view settings 171, as shown in block 314. If the user would like to access and edit parameters 170, a list storing at least one parameter 170 is accessed from a storage device and then displayed on the display device 26, as shown in block 302. In one embodiment, parameters list code is provided on a storage device for providing a general list that lists at least one parameter 170 that can be adjusted in the image-forming machine 20. Upon viewing the parameter 170 the user may then proceed and adjust the value of the parameter 170, as shown in block 304. In one embodiment, adjust parameters code is provided on a storage device for allowing a user to adjust a parameter 170. Once the user adjusts a selected parameter, the program 58 generates printer language signal 60 which includes printer language 61, and more specifically, low-level commands 134, as shown in block 306. The printer language signal 60 is then transmitted to image-forming machine 20, and more specifically, devices within image-forming machine 20, in order to adjust the selected parameters 170, as shown in block 308. In one embodiment, transfer code is provided on a storage device for transferring an adjusted parameter 170 from the storage device to cache memory in the image-forming machine 20. Preferably, parameters 170 are adjusted dynamically, that is, while the image-forming machine 20 is in operation, so the user can view the changes in “real time.” Once the parameters 170 are adjusted, the user may decide at block 310 to continue with the program 58 and go back to block 301 or end the program 58 at block 312. In one embodiment, copy code is provided on a storage device for copying an updated parameter 170 from cache memory in the image-forming machine 20 to a nonvolatile memory in the image-forming machine 20.

If the user chooses to access and view settings 171, the program 58 accesses a list storing at least one setting 171 from a storage device, as shown in block 314. Upon accessing the setting 171, the program 58 then generates printer language signal 60 which includes printer language 61, and more specifically, status information 136, as shown in block 316. The printer language signal 60 is then transmitted to image-forming machine 20, and more specifically, devices within image-forming machine 20, in order to prompt the devices to generate status information 136 detailing the current value for the setting 171, as shown in block 318. The status information 136 generated by the devices is then received by the program 58, as shown in block 320. Preferably, the value for the setting 171 contained in the status information 136 is received dynamically, that is, while the image-forming machine 20 is in operation, so the user can view the value for the setting 171 in “real time.” Once the status information 136 is received by the program 58, the program 58 then displays the current value for the setting 171 on the display device 26. Once the settings 171 are displayed, the user may decide at block 310 to continue with the program 58 and go back to block 301 or end the program 58 at block 312. In this manner, testing of a new image-forming machine, or new sub-component within an image-forming machine, can be quickly evaluated toward determining optimal parameters.

Accordingly, by providing a program 58 that is capable of generating a printer language signal that includes low-level commands 134, the program 58 is able to prompt devices within the print engine 30 to generate status information 136 regarding the current value of settings 171 for devices within the image-forming machine 20. Additionally, since program 58 can generate a printer language signal that includes low-level commands 134, program 58 can be used to adjust parameters 170 for certain devices within the image-forming machine 20, thus allowing the user to control and test these devices. By providing the user with a way to dynamically control device within the image-forming machine 20, the user is able to reduce the amount of time required to test and configure devices within the image-forming machine.

As will be appreciated by those of skill in this art, the preceding examples are provided, not to limit or define the scope of the present invention, but to illustrate the nature of the present invention and possible uses for the teachings of the present invention. These examples may be modified in many different ways while still obtaining the benefits of the teachings of the present invention.

While the invention has been described and illustrated, this description is by way of example only. Additional advantages will occur readily to those skilled in the art, who may make numerous changes without departing from the true spirit and scope of the invention. Therefore, the invention is not limited to the specific details, representative machines, and illustrated examples in this description. Accordingly, the scope of this invention is to be limited only as necessitated by the accompanying claims.

1. A method of adjusting a parameter of a device within an image-forming machine comprising:
providing an image-forming machine with a storage device, wherein the storage device stores the parameter; and
dynamically adjusting the parameter stored in the storage device.

2. The method of claim 1 further comprising:
providing the image-forming machine with a cache memory in communication with the storage device, wherein both the cache memory and the storage device store the parameter.

3. The method of claim 2 further comprising:
dynamically adjusting the parameter stored in the cache memory; and
copying the adjusted parameter from the cache memory to the storage device.

4. The method of claim 1, wherein the parameter stored in the storage device is remotely adjusted by a user.

5. The method of claim 4 further comprising a computer remote from the image-forming machine, wherein the computer communicates with the image-forming machine using a printer language, and wherein the printer language includes commands for adjusting the parameter.

6. The method of claim 1, wherein the parameter comprises at least one of an engine setting, a belt setting, a toner station setting, and a voltage setting for a device within the image-forming machine.

7. An image-forming machine comprising
a processor;
a cache memory in communication with the processor, wherein the cache memory stores a parameter; and
storage device in communication with the cache memory, wherein the parameter is copied from the cache memory to the storage device.

8. The image-forming machine of claim 7, further comprising nonvolatile memory, wherein an initial set of parameters are copied from nonvolatile memory to the cache memory, and wherein an adjusted set of parameters are copied from the cache memory to the nonvolatile memory.

9. The image-forming machine of claim 7, wherein the parameter comprises at least one of an engine setting, a belt setting, a toner station setting, and a voltage setting for a device within the image-forming machine.

10. The image-forming machine of claim 7 further comprising an input/output port in communication with the storage device, wherein the input/output port is also in communication with a remote computer.

11. The image-forming machine of claim 10, wherein the remote computer communicates with the image-forming machine through a printer language, and wherein the printer language includes low-level commands for adjusting the parameter.

12. The image-forming machine of claim 7, wherein the storage device includes firmware.

13. The image-forming machine of claim 12, wherein the firmware is operated by the processor.

14. A computer program for dynamically adjusting parameters in an image-forming machine comprising:
a storage device;
parameters list code on the storage device for providing a general list that lists at least one parameter that can be adjusted in the image-forming machine;
adjust parameters code on the storage device for allowing a user to adjust the parameter;
transfer code on the storage device for transferring the adjusted parameter from the storage device to a cache memory in the image-forming machine.

15. The computer program of claim 14 further comprising copy code on the storage device for copying the updated parameter from the cache memory to a nonvolatile memory.

16. The computer program of claim 14, wherein the parameters list code lists parameters for at least one of engine settings, belt settings, toner station settings, and voltage settings.

17. The computer program of claim 14 further comprising printer language code on the storage device for communicating with the image-forming machine.

18. The computer program of claim 17, wherein the printer language code includes low-level commands for communicating with the image-forming machine.

19. A printer language for sending and receiving information to and from an image-forming machine, comprising:
command information having low-level commands for controlling devices within the image-forming machine and high-level commands for controlling higher level devices within the image-forming machine.

20. The printer language of claim 19 further comprising status information regarding the state of a device within the image-forming machine.

21. The printer language of claim 19 further comprising data information.

22. The printer language of claim 19, wherein the low-level commands include instructions that are used to directly control devices in the image-forming machine without having to be processed.

23. The printer language of claim 19, wherein the low-level commands include information used to control devices within a print engine of the image-forming machine.

24. The printer language of claim 19, wherein the low-level commands include information used to prompt devices within a print engine of the image-forming machine for information.

25. A computer program for dynamically adjusting parameters in an image-forming machine comprising:
a storage device;
low-level command generation code on the storage device for generating a low-level command for controlling devices within the image-forming machine; and
high-level command generation code on the storage device for generating a high-level command, wherein the high-level command must be processed further in order to control devices within the image-forming machine.

26. The computer program of claim 25 further comprising status information reception code for receiving status information regarding the state of a device within the image-forming machine.

27. The computer program of claim 25 further comprising data information generation code for generating information that is specific for reproducing a particular image.

28. The computer program of claim 25, wherein the low-level command includes instructions that are used to directly control devices in the image-forming machine without having to be processed.

29. The computer program of claim 25, wherein the low-level command includes information used to control devices within a print engine of the image-forming machine.

30. The computer program of claim 25, wherein the low-level command includes information used to prompt devices within a print engine of the image-forming machine for information.
